(19) United States
(12) Patent Application Publication
(10) Pub. No.: US 2019/0263984 A1
(43) Pub. Date: Aug. 29, 2019

(54) THIN FILMS COMPRISING PLASTICIZER-FREE POLYVINYL-CO-ACETAL

(71) Applicant: KURARAY EUROPE GMBH, Hattersheim (DE)

(72) Inventors: Michael FRANK, Nieder-Olm (DE); Niklas STEINBACH, Frankfurt (DE)

(73) Assignee: KURARAY EUROPE GMBH, Hattersheim (DE)

(21) Appl. No.: 16/319,423

(22) PCT Filed: Jul. 5, 2017
(86) PCT No.: PCT/EP2017/066719

§ 371 Date: Jan. 21, 2019

(30) Foreign Application Priority Data
Jul. 19, 2016 (EP) 16180250.9

(51) Int. Cl. C08J 5/18; B32B 7/12; B32B 5/02; C08K 5/07; B32B 27/30

(52) U.S. Cl. CPC C08J 5/18; B32B 7/12; B32B 5/024; B32B 5/022; C09J 129/04; B32B 27/306; C08K 2201/019; C08K 2201/014; C08K 5/07

(57) ABSTRACT

Polyvinyl-co-acetal films having a thickness of 1 μm to 1000 μm and containing less than 10 wt. % plasticizer are suitable for use as a hot melt in molding operations, exhibiting shorter cycle times as compared to conventional polyvinyl acetals. The polyvinyl-co-acetals are obtained by reacting at least one polyvinyl alcohol with at least two different aliphatic keto compounds, each containing 2 to 10 carbon atoms.

### CROSS REFERENCE TO RELATED APPLICATIONS

This application is the U.S. National Phase of PCT Appin. No. PCT/EP2017/066719 filed Jul. 5, 2017, which claims priority to European Application No. 16180250.9 filed Jul. 19, 2016, the disclosures of which are incorporated in their entirety by reference herein.

### BACKGROUND OF THE INVENTION

### 1. Field of the Invention

The present invention is directed to polyvinyl-co-acetal films containing little or no plasticizer, and to the use of such a film.

### 2. Description of the Related Art

Films comprising polyvinyl acetal have been long used as adhesive layers for laminating glass, polymers or fibers. Especially, plasticized polyvinyl acetal films are widely used as an adhesive layer for glass-glass laminates in automotive use.

Such films contain usually between 15 and 30% by weight of plasticizer. For use with polycarbonate layers, plasticized films are unsuitable, since plasticizer migrates into the polycarbonate which lessens the mechanical stability and optical properties of the polycarbonate sheet.

Plasticizer-free films from polyvinyl acetal are known for use as adhesive layers for non-woven fabrics. For example WO 2013124147A1 discloses the use of plasticizer-free films containing polyvinyl butyral (PVB) for laminating layers of aromatic polyamide fibers.

It was found that films containing polyvinyl butyral (PVB) have a rather low softening temperature. When using such films for lamination purposes, long cooling is necessary to fix the desired shape of the laminate and/or to prevent delamination.

Accordingly there was a need for films having a higher softening temperature and/or higher processing temperature during lamination processing.

### SUMMARY OF THE INVENTION

Surprisingly, it has now been found that films based on polyvinyl-co-acetals are suitable as adhesive layer and poses higher softening temperatures than the respective homo-polyvinylacetals.

An object of the invention is therefore a Film comprising polyvinyl-co-acetal having a thickness of 1 μm to 1000 μm, and less than 10 wt % of one or more plasticizers wherein the polyvinyl-co-acetal is obtained by reacting at least one polyvinyl alcohol with at least two different aliphatic keto compounds each containing 1 to 10 carbon atoms.

### DETAILED DESCRIPTION OF THE PREFERRED EMBODIMENTS

The films according to the invention may be obtained by reacting at least one polyvinyl alcohol with a first and a second aliphatic keto compounds wherein the first aliphatic keto compound has at least one carbon atom less that the second aliphatic keto compound.

In another embodiment of the invention, the polyvinyl-co-acetal is obtained by reacting at least one polyvinyl alcohol with first and second aliphatic keto compounds and the ratio of the groups of the polyvinyl-co-acetal originating from the first aliphatic keto compound and the second aliphatic keto compound is between 20:80 and 50:50.

In a preferred embodiment of the invention, the polyvinyl-co-acetal is obtained by reacting at least one polyvinyl alcohol with acetaldehyde as a first aliphatic keto compound and (n)- and/or (iso)-butyraldehyde as a second aliphatic keto compound.

The film preferably has a thickness between 10 and 300 μm, preferably between 30 and 250 μm, and most preferably between 40 and 110 μm.

Preferably, the polyvinyl-co-acetals used in this invention have a polyvinyl acetate content of 1 to 20% by weight, particularly 1 to 10% by weight, and a polyvinyl alcohol content of 10 to 35% by weight, more preferably 11 to 27% by weight, and in particular 16 to 21% by weight.

The degree of polymerization Pw of the polyvinyl-co-acetals is preferably between 100 and 1000, more preferably between 100 and 800 and in particular between 100 and 500.

Suitable polyvinyl-co-acetals have a molecular weight sufficiently high to form self-supported films either by extrusion or by solvent casting processes. A suitable molecular weight of the polyvinyl-co-acetals can be expressed by the viscosity, ranging from 5 mPas to 3000 mPas, preferably between 5 mPas to 2500 mPas, in particular 5 to 2000 mPas, and especially 20 to 200 mPas.

When producing the polyvinyl-co-acetals used in accordance with the invention, it is preferred to use a mixture of acetaldehyde with n-butyraldehyde and/or iso-butyraldehyde for acetalisation. The proportion of acetal groups in the polyvinyl-co-acetal resulting from n-butyraldehyde and/or iso-butyraldehyde is preferably at least 50 mol %.

The polyvinyl alcohol used to produce the polyvinyl-co-acetals can be utilized as a single component or in the form of a mixture of polyvinyl alcohols having a different degree of polymerization or degree of hydrolysis.

The polyvinyl alcohol content of the polyvinyl-co-acetals is preferably 10 to 25% by weight, more preferably 18 to 23% by weight.

The film laminates or layers according to the invention are generally produced by extrusion or solvent casting. In the extrusion process certain properties, for example melt pressure, melt temperature, and die temperature may be adjusted to obtain or avoid melt fracture i.e. to obtain or avoid a stochastic surface roughness.

Alternatively, a film laminate already produced according to the invention already produced can be embossed with a generally non-stochastic roughness by an embossing process between at least one pair of rolls.

Irrespective of the production method, films according to the invention may be provided with surface structure, applied on one side or more preferably on both sides, with a roughness R_{Z} of 15 to 150 μm, preferably an R_{Z} of 15 to 100 μm, more preferably an R_{Z} of 20 to 80 μm, and in particular, an R_{Z} of 40 to 75 μm.

In another embodiment, films according to the invention have substantially no surface structure, for example a roughness R_{Z} of 0 to 5 μm.

The polyvinyl-co-acetal film of the present invention is manufactured by extrusion, for example with a blown film extrusion line, or preferably by a cast extrusion process using a flat film die and chill roll since then the shrinkage values are very low. Processing temperatures for the extrusion line are between 200 and 250° C., preferably between 240 and 250° C. The flat film die is heated between 250 and 280° C., preferably between 260 and 275° C.

The polyvinyl acetal films may contain up to 2 wt % preferably less than 1 wt % of additives, and especially less than 0.5% wt % additives.

As additives, inorganic fillers such as pigments, dyes or clays, UV stabilizers, oxidation stabilizers or water may be employed.

Suitable UV stabilizers may be amine based, for example tetramethyl piperidine. In addition to primary, secondary and tertiary linear amines, sterically hindered amines known as ‘HALS’ products may be employed as co-stabilizers in connection with polynuclear phenolic compounds.

As inorganic fillers, SiO₂, optionally doped with Al₂O₃ or ZrO₂, can be added.

Films according to the invention may comprise up to 10% by weight plasticizer, for example one or more of the following plasticizers: water, di-2-ethylhexyl sebacate (DOS), di-2-ethylhexyl adipate (DOA), dihexyl adipate (DHA), dibutyl sebacate (DBS), triethylene glycol-bis-n heptanoate (3G7), tetraethylene glycol-bis-n-heptanoate (4G7), triethylene glycol-bis-2-ethyl hexanoate (3GO or 3G8), tetraethylene glycol-bis-n-2-ethyl hexanoate (4GO or 4G8), di-2-butoxyethyl adipate (DBEA), di-2-butoxyethoxyethyl adipate (DBEEA), di-2-butoxyethyl sebacate (DBES), di-2-ethylhexyl phthalate (DOP), di-isononyl phthalate (DINP), triethylene glycol-bis-isononanoate, triethylene glycol-bis-2-propyl hexanoate, 1,2-cyclohexane dicarboxylic acid diisononyl ester (DINCH), tris(2-ethylhexyl) phosphate (TOF) and dipropylene glycol benzoate.

Preferably, films according to the invention comprise less than 5% by weight plasticiser, more preferably less than 2% by weight, and most preferably no (0%) plasticizer.

Film according to the invention can be used as a hot melt adhesive, especially for fabrics.

### EXAMPLES

Two films of 50 μm thickness were prepared by solvent casting of two different polyvinyl acetals. Polyvinyl acetal A was prepared using only butyraldehyde, polyvinyl acetal B was obtained by acetalisation of polyvinyl alcohol with a 50:50 mixture by weight of acetyldehyde and butyraldehyde.

| | Hydroxyl | Acetyl | |
|---|---|---|---|
| Polymer | Content | Content | Viscosity |
| Acetal A | 19.2 wt. % | 1.3 wt. % | 205 mPa * s |
| Acetal B | 19.6 wt. % | 1.5 wt. % | 200 mPa * s |

A fibre composite was prepared by stacking sheets of the polymer film and woven fabrics of Vectran 1670 dtex liquid crystal polymer fibre (available from Kuraray Europe GmbH, Hattersheim) with the following stacking scheme: Fabric/Polymer film/Fabric/Polymer film/Fabric/Polymer film/Fabric/Polymer film/Fabric.

The stack was pressed at 120° C. and 10 bar pressure in a heated press. For polyvinyl acetal A, the composite had to be cooled to 70° C. to be removed without distortions of the composite whereas composites based on polyvinyl acetal B had to be cooled only to 90° C.

With a cooling and heating rate of 10 K/min, this resulted in a 4 minutes shorter production cycle of composites based on polyvinyl acetal B compared to those based on polyvinyl acetal A (2 minutes shorter cooling and 2 minutes shorter reheating the press for the next cycle.

1.-10. (canceled)

11. A film composition comprising at least one polyvinyl-co-acetal film having a thickness of from 1 μm to 1000 μm and containing less than 10 wt. % of plasticizer, wherein the polyvinyl-co-acetal is obtained by reacting at least one polyvinyl alcohol with at least two different aliphatic keto compounds each containing 2 to 10 carbon atoms.

12. The film of claim 11, wherein the polyvinyl-co-acetal is obtained by reacting at least one polyvinyl alcohol with a first aliphatic keto compound and a second aliphatic keto compound, wherein the first aliphatic keto compound has at least one carbon atom less that the second aliphatic keto compound.

13. The film of claim 11, wherein polyvinyl-co-acetal is obtained by reacting at least one polyvinyl alcohol with a first aliphatic keto compound and a second aliphatic keto compound, and the ratio of the groups of the polyvinyl-co-acetal originating from the first aliphatic keto compound and the groups originating from the second aliphatic keto compound is between 50:50 and 20:80.

14. The film of claim 11, wherein polyvinyl-co-acetal is obtained by reacting at least one polyvinyl alcohol with acetaldehyde as a first aliphatic keto compound and (n)- and/or (iso)-butyraldehyde as a second aliphatic keto compound.

15. The film of claim 11, wherein the polyvinyl-co-acetal has a content of vinylacetate groups between 0.1 and 25 wt. %.

16. The film of claim 11, wherein the polyvinyl-co-acetal has a molecular weight Mw of 20,000-150,000 g/mol.

17. The film of claim 11, wherein the polyvinyl-co-acetal has a degree of acetalization of 60-89 wt. %.

18. The film of claim 11, wherein the polyvinyl-co-acetal has a content of vinylalcohol groups of 10-30 wt.-%.

19. The film of claim 11, containing less than 5 wt. % plasticizer.

20. The film of claim 11, containing no plasticizer.

21. A hot melt adhesive comprising a film of claim 11.

22. The composition of claim 11, comprising a composite structure prepared by heating at least two fabric layers with the polyvinyl-co-acetal film, and cooling to produce a structure in which the at least two fabric layers are bonded to each other by means of the polyvinyl-co-acetal film.

23. The composition of claim 22, wherein the composite structure contains three or more fabric layers, and polyvinyl-co-acetal films between fabric layers.
